(19) United States
(12) Patent Application Publication
(10) Pub. No.: US 2015/0090668 A1
(43) Pub. Date: Apr. 2, 2015

(54) LIQUID TREATMENT REFINING, RECYCLING AND TESTING DEVICE

(71) Applicant: HOWARD SCHACHTER, RIVERSIDE, RI (US)

(72) Inventor: HOWARD SCHACHTER, RIVERSIDE, RI (US)

(21) Appl. No.: 14/497,375

(22) Filed: Sep. 26, 2014

Related U.S. Application Data
(60) Provisional application No. 61/883,835, filed on Sep. 27, 2013.

(51) Int. Cl. C02F 9/00

(52) U.S. Cl. CPC C02F 9/005; C02F 1/78
USPC 210/732; 210/200; 210/138; 204/660; 205/742

(57) ABSTRACT

A mobile water treatment facility may include, in one example operation, receiving used, dirty and/or waste water from a well or other source. The water may then be prepared for a treatment cycle by modifying the water and applying a voltage to the water inside an electrode array in order to remove the sediment from the water to provide recycled water for continued use. The process may be performed by a full capacity device or via a mobile treatment and testing unit that operates by cycling the water at a smaller volume and rate for analysis and testing purposes prior to engaging a full flow-rate treatment device.

### CROSS-REFERENCE TO RELATED APPLICATIONS

This application claims priority to earlier filed provisional application No. 61/883,835 filed on Sep. 27, 2013 and entitled “LIQUID TREATMENT REFINING, RECYCLING AND TESTING DEVICE”, and is related to earlier filed application Ser. No. 14/038,130 filed on Sep. 26, 2013 and entitled “METHOD AND APPARATUS FOR RECYCLING WATER USED WITH HEAVY INDUSTRIAL PURPOSES” the entire contents of which are hereby incorporated by reference.

### TECHNICAL FIELD OF THE APPLICATION

This application relates to a method and device used for recycling, filtering and/or removing minerals and other sediment from water that has been exposed to an industrial work cycle and performing tests to identify the composition of the water after the treatment is performed.

### BACKGROUND OF THE INVENTION

Conventionally, water or similar liquid compositions may be used to perform drilling and may also be used for other industrial purposes. The amount of water available for use may be inversely proportional to the remoteness of the site where the drilling occurs. Also, clean or sediment free water being brought to remote locations is a large expense which results in losses in profits or other degradations in the mining process.

In one conventional example, water must be brought to a drill site and added to the drilling spot to cool and soften the earth in the case of mining oil or other deep ground resources. Once the water has been exposed to the earth, dirt and sediment of the mining drill bit or other machinery, the water becomes murky, dark and saturated with minerals and other sediments which must be removed before the water can be used again.

In another example, water may be used for hydraulic fracturing, which is the propagation of fractures in a rock layer, as a result of the action of a pressurized fluid. Some hydraulic fractures form veins or dikes, and can create conduits along which gas and petroleum from source rocks may migrate to reservoir rocks. Induced hydraulic fracturing or ‘hydrofracking’, commonly known as ‘fraccing’ or ‘fracking’, is a technique used to release petroleum, natural gas (including shale gas, tight gas and coal seam gas), or other substances for extraction. This type of fracturing creates fractures from a wellbore drilled into reservoir rock formations.

Regardless of the water use purpose, the water on-site would ideally be re-used again, and again, without any delay so the mining and drilling can be performed continuously. Unfortunately, the water is often saturated with sediment and mineral deposits rather quickly and must be pumped out of the mining channel so new fresh water can be added for continuous mining operations. Also, a mobile test and treatment device may provide a way to identify the results to be expected from a full rate treatment cycle and device.

### SUMMARY OF THE INVENTION

One example embodiment may provide an apparatus that includes a liquid input source that provides a predetermined number of liquid gallons, and a gas input source that provides a gas injection to the liquid. The apparatus may also include an electrode array that includes a plurality of electrodes configured to receive the liquid and apply a direct current voltage to the liquid.

Another example embodiment may provide a method that includes receiving a flow of liquid via a forced liquid input interface, receiving a gas injection via a gas input interface and mixing the gas with the liquid, applying a voltage to the liquid for a predetermined amount of time, and reversing the polarity of the voltage and applying the reversed polarity voltage to the liquid.

Another example embodiment may include an apparatus that provides an array of electrode cells configured to store a liquid, a liquid interface source that provides a flow of liquid into the array of electrode cells, the liquid comprising a plurality of sediment materials, a power supply interface in contact with the liquid and configured to receive a voltage source, and a chemical interface configured to receive a polymer that mixes with the liquid in the electrode cells during application of the voltage source.

Another example embodiment may include an apparatus that includes a liquid source input channel, a power supply configured to provide a direct current (DC) voltage, and an electrode array which includes a plurality of liquid holding electrodes configured to receive a liquid from the liquid source input channel and apply a direct current voltage to the liquid for a predetermined period of time.

One example method of operation may include receiving a direct current (DC) voltage at an electrode array which includes a plurality of liquid holding electrodes, receiving a liquid at the electrode array from a liquid source input channel, and applying the DC voltage to the liquid in the electrode array for a predetermined period of time.

Another example apparatus may include a filter configured to filter oil from a liquid, an ozonator configured to add ozone to the liquid, and an array of electrode cells configured to store the liquid for a predetermined amount of time and receive and apply a direct current (DC) voltage for the predetermined period of time to the liquid, and after the predetermined period of time a reverse polarity DC voltage is received and applied to the liquid for a predetermined period of time.

### BRIEF DESCRIPTION OF THE DRAWINGS

FIG. 1 illustrates an example of a water treatment device according to example embodiments.

FIG. 2 illustrates an example of the electrode and voltage application portion of the water treatment device according to example embodiments.

FIG. 3 illustrates an example of the water flow and storage tank device used with the water treatment device according to example embodiments.

FIG. 4 illustrates an example configuration of the mobile treatment and analytical laboratory.

FIG. 5 illustrates a flow diagram of an example method of operation.

### DETAILED DESCRIPTION OF THE INVENTION

It will be readily understood that the components of the present invention, as generally described and illustrated in the figures herein, may be arranged and designed in a wide variety of different configurations. Thus, the following detailed description of the embodiments of a method, apparatus, and system, as represented in the attached figures, is not intended to limit the scope of the invention, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

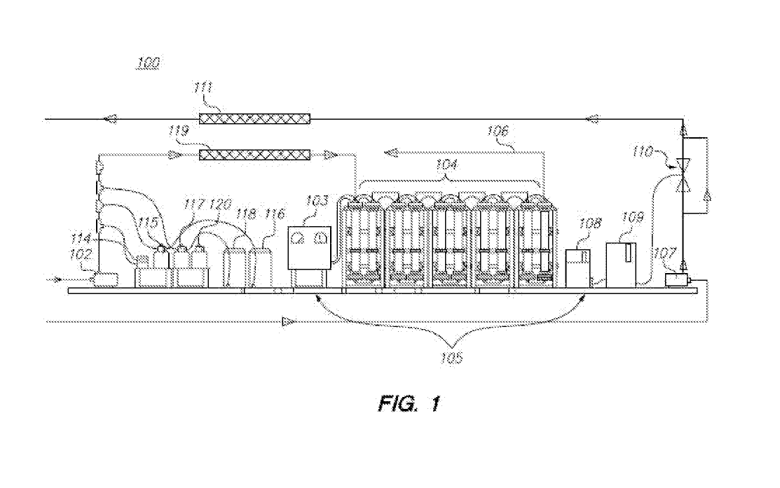

FIG. 1 illustrates an example water treatment and refinement device configuration. Referring to FIG. 1, the various items of the water treatment device 100 are exemplary in nature and may be modified by one skilled in the art to accommodate various design considerations according to the example embodiments.

In one example, piping and valves used for water flow may be schedule-40 PVC grade. Other piping considerations may be copper or other types of plastic. The electric water pump 102 may be a 3.0 HP centrifugal 50 gallons per minute (GPM) grade pump, however, a faster or slower pump may operate as well to pump the “used”, “frac” or “dirty” water into the water treatment device. According to other example embodiments, the pump size may be 10 HP with a flow rate of 125 GPM.

Within the water flow system of pipes moving through the water treatment device, a set of six electrocoagulation chambers or ‘electrodes’ may be part of an electrode array 104 used to treat the water and remove sediment from the used water. The number of electrodes may be greater or fewer depending on the amount of water flow, the degree or amount of sediment included in the water and the level of current and/or voltage provided by each electrode. The power supplied may be from a 200 ampere electrocoagulation DC power supply 103. The electrode array may have 10 electrode chambers according to example embodiments.

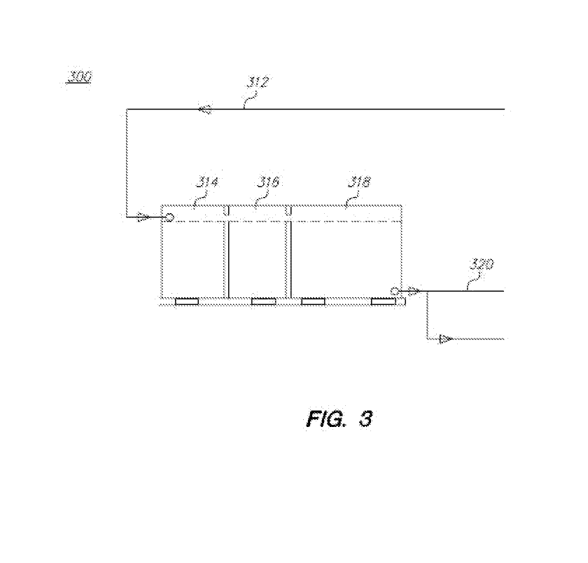

The water treatment system may be fully palletized in a self-contained module 105 for easy forklift compatibility and mobility. The ozone generation of water treatment may also be part of a high efficiency corona discharge type of operation. For example, a recirculation pump 107 may be used to generate a 3.0 horse power (HP) centrifugal pump cycle of 50 GPM of water flow. The pump 107 may also be a 7.5 HP pump at 125 GPM. An oxygen concentrator module 108 may generate the oxygen molecules needed for the ozone injection module 109 to inject the ozone via an ozone injection interface 110. The pump may be used to generate a 16 gallon per-minute flow via an injector module. The ozonated water is then sent through a static mixer 119 for further ozone saturation. The ozonated water is then recirculated back to the main storage tank 300 of FIG. 3. The tanks of FIG. 3 are for example purposes only and are not intended to limit the scope of the water treatment device and/or the methods of water treatment. The tanks or water treatment chambers may be made by any third party manufacturer and are merely auxiliary components of the example embodiments of the present application.

A chemical metering pump 115 may be used to administer a pH adjusting chemical stored in the acid/alkaline tank 116. A polymer feeding pump 117 may be used for adjusting polymer content levels from a polymer stored in polymer tank 118 that is used to bind to the sediment in the water and create a heavy solid that is denser than the water and which falls via gravity to a lower position in the electrode chambers 104 and may be easily removed via a filter or tray removal operation at the bottom of the electrode array. The backup pump 120 may be used in case of a pump failure. The pH monitoring device 114 provides an automatic pH adjustment action to maintain the pH at a particular level by initiating the pH pump to add more acid/alkaline or stop adding pH adjustment chemicals to the water. Also a totalizer or transmitter 106 may be integrated into the flow of water to identify the total volume currently being treated at a particular time interval. The resulting treated water is returned through a return pipe 111 to be reused.

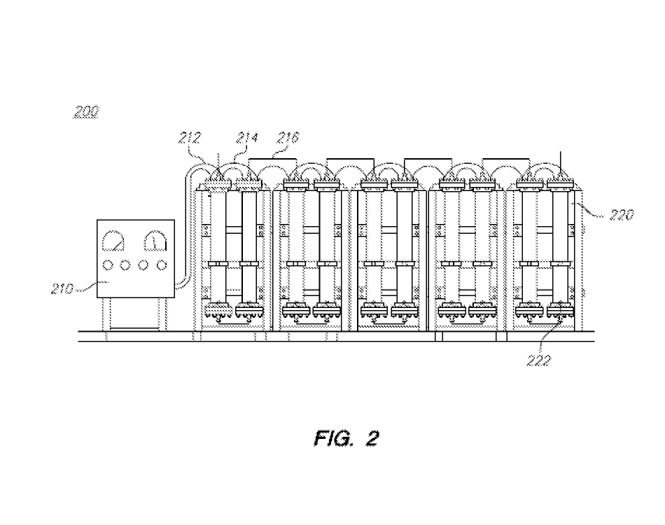

An electro-coalescing scenario may include ozones being injected in the water during primary stages and continuously during the electrode chamber refinement procedure. Once the used, dirty and/or waste water enters the electrode assembly of six electrodes (see 104 of FIG. 1 or 200 of FIG. 2) laid in a series configuration, the electric charge exposed to the water may be conducted during the water flow procedure from electrodes 1-6 or in other examples 1-10. The electrodes provide a DC voltage source that provides a DC current to the water that causes the metals and other minerals to begin binding together into clusters based on a varying DC voltage source coupled to the electrodes.

According to one example embodiment, the DC voltage provided by the voltage source may be provided to each electrode uniformly at a set interval of time (e.g., 15, 30, 45, 60, 75, 90 seconds, etc.). For example, a DC voltage may be applied to the electrodes so one portion of each electrode is generating a current based on first voltage polarity (i.e., positive or negative) from one electrode portion to the other of the two electrode portions (anode and cathode) in each electrode chamber or cell.

The anode in each of the electrochemical cells may be defined as the positive electrode at which electrons leave the cell and oxidation occurs, and the cathode may be the negative portion of the electrode where at which electrons enter the cell and reduction occurs. Each electrode rod in FIG. 1 may become either the anode or the cathode depending on the direction of current through the cell. Each of the three pairs of electrodes includes three anodes and three cathodes. Or, alternatively may include 5 anodes and 5 cathodes in the case of additional electrodes.

Among the different types of electrodes, a primary cell is a special type of electrochemical cell in which the reaction cannot be reversed, and the identities of the anode and cathode are therefore fixed. The anode is always the negative electrode. The cell can be discharged but not recharged. In another type of electrode, a secondary cell (e.g., a rechargeable battery) may be an electrode in which the chemical reactions are reversible. When the cell is being charged, the anode becomes the positive (+) and the cathode the negative (−) electrode. This is also the case in an electrolytic cell. When the cell is being discharged, it behaves like a primary cell, with the anode as the negative and the cathode as the positive electrode.

According to example embodiments, on a continuous basis, the positive and negative DC voltage applied to each portion of the electrodes is reversed after a predetermined time constant. For example, a DC voltage that is set in a first phase of operation may apply a DC voltage to the electrodes for a time period of 30-90 seconds. Once the predetermined amount of time has expired, the DC voltage may be reversed so that the electrode assembly reverses the positive to negative flow of current. In other words, each of the positive voltage electrode cells or chambers may be reversed to a negative voltage for an equal amount of time. The reverse in DC voltage polarity will reduce the amount of sediment deposits from over growth and will cause cluster forming to occur. The clusters may be formed and the polymer solution added to the water is then able to react to the clusters and form heavy solids which promptly fall from suspension in the cathode water cells and are easily removed by a filtering or other sediment removal process. Once the solids have reacted with the polymers the sediment will collect on the bottom of the electrodes and may be removed via any known filtering operation.

The electrodes are coupled to a DC power supply that delivers, voltage while the waste water is forced through the electrodes at a predetermined rate (GPM). The electrical charge is applied to the electrodes identically in a uniform manner. Alternatively, the voltage is applied in an alternating variation of one electrode at a time receiving a particular voltage and polarity and the next electrode receiving a different voltage and polarity than the previous electrode in the electrode array.

The ten electrode assembly of FIG. 2 includes identical electrodes. More electrodes may be added if necessary in a series configuration so the same water may flow from each electrode until all of the electrodes have processed the same set of water that has flowed from one electrode to another in a series configuration. The electrodes may be bi-metallic each electrode having two different metals in concert with the water, such as aluminum and steel, one then the other which are not the same. Each electrode is exposed to all the water, and all electrodes carry the same charge.

One example configuration includes a voltage source 210 applying a constant DC voltage to each of the plurality of electrodes 220 for a predetermined amount of time (e.g., 30-90 seconds). After the time has expired, the voltage is reversed from a positive voltage to a negative voltage for another predetermined amount of time (e.g., 30-90 seconds).

In operation, an oscillating DC current is set for a first polarity for a predetermined time interval. Upon expiration of the predetermined time interval, the DC voltage changes polarity and oscillates back to a different DC current direction than the first current direction. According to one example, the time interval is 60-90 seconds that the voltage stays positive then moves back to negative for a 100 gallon a minute system. Multiple intervals of DC voltage oscillation may occur in a single cycle of water treatment for a single portion of water.

With the oscillation current changing, sediment clusters are forming in the water based on the coalescing and coagulation cycle. A final chemical being added consolidates the cluster metals and non-metals to create positive ions and negative ions (anions and cations) based on the cathode and anode in each electrode. For example, an anode after 60 seconds may become an anode. The anode would have a buildup of sediment if oscillation of the DC voltage did not occur. The cathode and anode are constantly changing reversing polarity every interval.

The change in polarity causes cluster formation, and free-falling of the metals, the anions are nonmetals and the cations are metals, once the clusters are formed, the chemical polymer brings the clusters into a settling form that drops quickly to the bottom of the electrode chamber for removal. The metals and non-metals are kept from attaching to the electrodes. The attachment of the metals and non-metals is avoided by the periodic reversing of the DC voltage.

According to example embodiments of the water treatment device of FIG. 1, the initial step in the process is the transfer of the flow back “frac-water” volume from the “fracturing” process, which generally occurs at oil and gas wells being explored and drilled anywhere in the world. The configuration of FIG. 1 includes an “overflow” frac tank (see 300 of FIG. 3) that acts as an intercept of the water from the well site to be treated and which is a part of the treatment process because it enables solids to settle and offers a large enough basin for the wastewater process to proceed in an orderly manner of “pre-treatment” and it is after this “overflow frac tank” receives the fracturing and ground water from the well site that the treatment device of FIG. 1 begins its task of remediation.

Referring to FIG. 3, the dirty water may flow from a direct line 312 into a multiple part tank including a first tank portion 314, a second tank portion 316 and a third tank portion 318. The multiple tank configuration may be used to separate the water into designated chambers for pre-treatment prior to the water being pumped back out via the pump interface 320. According to example embodiment, the dirty water treatment may be a dual-technique that consists of a primary injection and pre-treatment utilizing a gaseous input referred to as “Ozone” that is a hybrid three-atom series of molecules that form a compound known as O₃, which has three atoms of oxygen.

The second phase of this dual-technique procedure is referred to as “electro-coalescing” that includes of a “direct current” power supply, electrical charges and a steady flow of “frac water” being combined in a series of bi-metallic electrode cells as illustrated in FIG. 2, which are exposed to a set of pH modification and polymer injection procedures. The “ozone” and “electro-coalescing” operations provide electro-chemical aggregation of heavy metals, organic and inorganic colloids, etc., to produce a coagulated mass capable of being easily separated (by gravity) or removed from the water by settling or filtration once the treatment procedure approaches completion.

The dual-operation procedure of the two sub-operations used to perform a frac water treatment cycle may provide isolating the ozone as an initial independent “pre-treatment” injection into the “frac tank” after receiving the frac water from a well site. The duration of this ‘pre-treatment” cycle is dependent on a volume of water entering the frac tank inventory. One standard rule may be for every 30,000 gallons of water entering the “frac tank” one hour of injection time is desired, and as a result a “closed loop” circulation of ozone enriched “frac water” may be employed.

Experimentation and test procedures demonstrated that “frac water” has a tendency to be generated in the “acid mode” (e.g., 5.0-6.5 pH) and as this occurs it has been established that the most successful treatment cycles can only be accomplished if the “frac water” has a modified pH level above 9.1-9.4 pH. Therefore, to assist with this pH modification operation a continuous injection of sodium hydroxide (NaOH) is metered into the frac water as it passes through the frac tank and eventually through the ozone generation cycle followed by entry into the electrode assemblies 200 en-route to a final electro-coalescing operation.

At this point, the “frac water” is pre-conditioned and ready to be moved forward into the next extraction cycle known as “coalescing”, which is where the frac water enters the treatment device and is diverted through a series of 10 electrode assemblies. The electrode assemblies are chambers where the water can make contact with 100 sacrificial metal electrodes and energized by a source of DC (direct current) power with an optional range of 200-400 amps DC.

Ozone by definition is a three (oxygen) atom molecule known as O₃ and it differs from the air breathed which contains a two (oxygen) atom molecule known as O₂. The smallest whole piece of any molecular element is an atom, which are electrically charged and are seldom stable by themselves. Single oxygen atoms are electrically attached together to form molecules and that is the same process used to form ozone. That oxygen atomic status becomes increasingly unstable and as this reaction goes to completion, air and oxygen are drawn through a high energy chamber that bombards the molecules causing them to split back into “singlet oxygen atoms”. A greater level of instability then takes place and the ozone (three atom) molecule is now in constant contact with other molecules in the “frac water”. As a result, there is a tendency for singlet oxygen atoms to be roaming which tends to pull electrical energy from these molecules and their molecular structure is now altered even to the point where solids are precipitated and coagulated. This process of “ozone attack” and “co-mingling” with other molecular structures is called “oxidation” and is part of the treatment component going forward to the next level of “frac water remediation”.

In order to produce suitable ozone for the frac water remediation process a source of oxygen must be available and air can be used except that since there is only 21% oxygen in air a more effective technique is to employ an oxygen concentrator that extracts the oxygen from the air and guarantees a minimum of 90% oxygen by using a high energy reaction chamber that splits the oxygen atoms away from nitrogen and facilitates the production of a high purity ozone (e.g., over 90% pure).

Electro-coalescing by definition is the term used to describe the process of flowing contaminated/dirty frac water directly between sacrificial metal electrodes connected to a source of direct current (DC) at 200-400 amps DC power. The power supply employs a discipline of reversing voltage polarity which is integrated with the electrode assemblies. This technique functions as a mechanism of creating metal hydroxides and non-metal hydroxides that are coagulated into clusters that make the waste water or frac water become a conductive medium in the presence of the DC electric field in and around the electrodes, thus enhancing the ease of coagulation, clustering, collection, settling or filtration as the frac water progresses through the system into a finished cleaner water.

Reversing voltage polarity refers to the fact that each electrode possesses a positive and negative electrical charge, however, every 90 seconds the power supply activates a reversing mechanism that reverses the charges so that each electrode cannot retain a charge long enough to impact sediment collections on each electrode. That concept further proves the efficient performance of the remediation procedure.

FIG. 2 illustrates an example of the electrode and voltage application portion of the water treatment device according to example embodiments. The electrode assembly 200 includes a DC power supply 210 connected to an electrode array of electrodes setup in series as pairs 220 of electrode chambers 222 where the electrical charge is configured to contact the frac water. The wire pair 212 provides a negative and positive polarity from the DC power supply to each electrode chamber 222. The chambers are paired by two connecting wires 214 which permit the positive and negative polarities of the voltage source to be striped across the two electrode chambers. A cross-over conduit 216 provides a series electrical connection to be striped across all electrodes of the electrode array 200.

The example methods of operation performed by the electrodes may destroy bacteria. For example, the electrical field along with the electro-chemical and oxidation reactions at the surface of the electrodes kills bacteria up to 99.9%. The process may oxidize metals and the process of electrolysis produces an oxidative effect which oxidizes the contaminants as they flow between the bi-metallic electrodes. This will enable the solids collected to meet the EPA toxicity characteristic leaching procedure (TCLP) standards. Also, cellular dewatering may occur so the electric field and high oxidation rate causes organisms and water bound cellular structures to rupture which further reduces sludge volumes.

Another feature of the present device and its operations provides coagulation by the electrical field within the electrode cells, which neutralizes the charge of contaminants and thus increasing their removal. As a result of the ozone and electro-coalescing operations, the treated water will have signs of clarity but may still carry a level of turbidity (microscopic suspended solids) due to the complex chemistry employed in the fracking and flow-back water. Those water sources may carry a high level of stable sulfates, surfactants and emulsifying agents along with petroleum hydro-carbons (TPH) and (VOC) (volatile organic compounds), which makes it difficult to eradicate and remove those substances 100% without some additional process assistance.

According to example embodiments, at this juncture the combination of “electro-coalescing” and “ozonation” have thoroughly made contact with 100% of the pH modified “fracturing water” and the result of these combined disciplines and methodology has now yielded only a “semi-treatment” of the water, and this partial treatment cycle, a microscopic colloidal suspension of the major contaminants may still be present due to the complex water chemistry being derived from the “fracturing” procedures that are not fully engaged by the “ozone and electro-coalescing” treatments.

The composition of the “fracking” colloidal chemistry could have varying grades of toxic and non-toxic contaminants and the following known potential contaminants contained in the “fracking and other wastewater” have been successfully removed in accordance with the following table of elements and parameters identified from previous experimentation. The following removal results are typical for “electro-coalescing and ozonation” performance in wastewater remediation applications:

| Contaminant: | % Removal |
|---|---|
| Aluminum | 99.0% |
| Arsenic | 98.0% |
| Barium | 95.0% |
| Bacteria (HTC) | 99.0% |
| Copper | 99.0% |
| Chromium | 99.0% |
| Iron | 99.0% |
| Lead | 98.0% |
| Magnesium | 98.0% |
| Manganese | 75.0% |
| Nickel | 98.0% |
| Oil and grease (500 ppm | 99.0% |
| Phosphate | 80.0% |
| Strontium | 60.0% |
| Silver | 99.0% |
| Zinc | 95.0% |
| Chlorides | 35.0% |
| Boron | 80.0% |
| Sulfates | 80.0%. |

The remediation procedure also includes a microscopic bio-degradable additive composed of an emulsified soluble substance with known chemistry including an “Aluminum Chloride Hydroxy-Sulfate” known as compound #316-G polymer. This compound in its raw state is a hazardous substance, however, once it is integrated into the waste water in the presence of the “electro-coalescing and ozonation” activity it is rendered bio-degradable and non-toxic as a safely disposable mass capable of being sanitary land-filled.

This revitalization of the #316-G polymer is now dissolved in the “fracking” waste water and exhibits a final gathering and coagulation of the sub-micron suspended colloids that are now engulfed, enlarged and transformed into large clusters of solids from approximately 20-100 micron in size and capable of being settled or filtered for off-site removal to a sanitary land-fill in compliance with EPA TCLP standards.

After the solids are extracted and removed, a high quality solids-free clear liquid is ready to return to the oil exploration well sites where both drilling and fracking procedures can be serviced with the benefit of replacing the scarce water commodity with a recycled “flow-back” water in its place reducing the task and cost of disposal and resulting in a cost effective environmentally sound “hydraulic fracturing” result. However, the process is modified and optimized by using the remediation treatment process discussed in this disclosure. In order to reduce added contaminants, an oil separation module may be added to the remediation procedure as an adjunct module that intercepts all water entering into the cycle prior to the ozone/electro-coalescing procedure.

According to another example embodiment, a mobile treatment and analytical laboratory may provide a compact and transportable laboratory and treatment facility that is built into a portable tow-behind trailer or comparable mobile vehicle which may be adapted for motor vehicle towing on roads and highways. This alternative embodiment may be a water treatment hydraulic fracturing ‘fracking’ and return water flow back treatment laboratory with both treatment processing functions and an analytical support function(s).

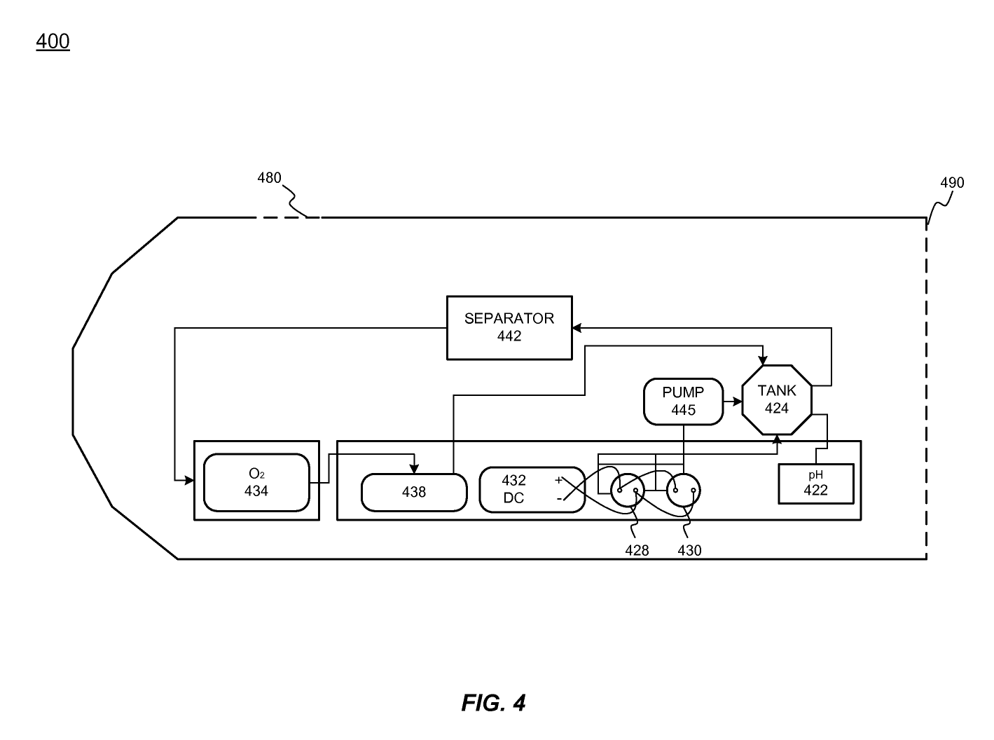

FIG. 4 illustrates an example configuration of the mobile treatment and analytical laboratory according to example embodiments. Referring to FIG. 4, the mobile treatment device 400 includes a consolidated water treatment system similar to the example device/system in FIG. 1. However, in the mobile unit the group of components may be housed in a mobile storage unit or trailer that is accessible via a motor vehicle and towed to a testing site. The rear door 490 exposes the laboratory and the system of components. A side door 480 may also be used to access the system.

Among the various components of the mobile treatment system is a pH monitor or pH meter 422 that is configured to monitor the pH level of the dirty or used water (hereinafter ‘water’) prior to exposing the water to the electrodes. If adjustments to the pH are needed then a pH adjusting agent may be added to the water accordingly. Also, the pH monitor 422 may provide information necessary for the operator to identify whether the water can be cleaned successfully or whether the pH information is required for additional analytics results and tests.

The 5.0 gallon receiving tank 424 may be used for water intake and to provide a source of dirty water for treatment and analysis. The tank 424 may be integrated into the closed loop water movement system of pumps, pipes and reservoirs used to treat and analyze the dirty water. The tank 424 may pump water from the pumping action of the pump 445, and may also receive the pH adjustment chemical from the pH meter 422. The tank 424 may be pumped via pump 445 to push water to the electrode array of electrodes 428 and 430. The pipe system illustrated in FIG. 4 is part of a manifold of flowing water guided in and out of the treatment device which recycles the water continuously delivering ozone from ozonator 438 based on an oxygen concentrator 434 and may also include other gases or liquids which are added to the water sample. The electrode assembly is an aluminum internal assembly with two electrodes 428 and 430 and may include multiple electrodes beyond the two illustrated in FIG. 4. The electrodes 428 and 430 are configured to receive the ozonated water and apply an electrical charge via a DC power supply source 432 to the water in the electrode for electro-coagulation performance. The electrodes are part of a closed loop pipe system that provides or channels the liquid to the electrodes 428 and 430. The oxygen concentrator 434, the ozonator 438, the power supply 432, the tank 422, the electrodes 428 and 430, the pump 445, and the separator 442 are all connected to the closed loop pipe system either directly or indirectly as illustrated in FIG. 4.

The oxygen concentrator 434 is attached to ozone generator and provides oxygen necessary to ozonate the water prior to electrical exposure to the water in the electrode array 428/430. Additional features may include an oil water separator 442 which filters the water to remove the oil prior to or contemporaneous with the removal of the sediments and minerals from the water. The mobile treatment and analysis unit is designed to process up to 5.0 gallons of frac, flow-back and/or produce water. The purpose of the mobile treatment unit 400 is to treat the frac water and then extrapolate the results to a 125 gpm hydro-pod system or device similar to that described above with reference to FIGS. 1 and 2. The design of the mobile treatment and analysis unit is to treat the water using certain treatment functions, such as oil/water separation (e.g., oil removal up to 25%), which is based on oil quantified after extraction. The function of the separator 442 may include a waste water sample that is selected for entry into the mobile unit and which is intended to be processed by placing it first into the tank 424 via manual delivery or via an automated pump. Prior to entering the tank 424, the waste water passes through the separator 442 at a flow rate of approximately 1.0 gallon per minute (GPM) and the oil is extracted and then extrapolated to the full capacity system described with reference to FIGS. 1-3 which takes in waste water at a rate of 125 GPM from a full scale oil water separator unlike the test unit size 442 of FIG. 4.

After the calculation of “oil content” is made from the incoming waste water sample the water is permitted to flow into tank 424 until all 5.0 gallons of waste water are positioned in place, the oil extracted and quantified and the “oil free” waste water then proceeds through the other portions of the “mobile test module” 400 illustrated in FIG. 4. In other words, the testing module 400 operates at 1 GPM but the full size production waste water treatment system operates at 125 GPM.

The operations performed by the mobile treatment device may include ozone, electro-coagulation, pH modification, polymer injection, filtration, a heating procedure for “final de-watering” and drying of the solids removed during filtration. Next, weighing of the dry matter may be performed to establish the quantity or magnitude of the solids content extracted from the original sample. The processing sequence of operations provides oil removal, polymer injection, filtration and drying all of which may be performed manually while the other operations (e.g., ozone injection, EC, pH modification, etc.) are all fully automatic and which proceed on a timing cycle.

The timing cycle is pre-set to be completed in 30 minutes and after that period expires the resultant sample will have had multiple contaminants removed and is now in a position for quantitative determinations that will assist in the evaluation of the water. To enable quantitative data to be accumulated, the laboratory module has an analytical phase that involves specific methodologies known as volumetric, gravimetric and colorimetric procedures and each of these disciplines are employed with two specific requirements which provide the examining and analyzing of the original sample before processing and the examining and analyzing of the final resulting sample after the entire process is complete.

By comparing the before the water treatment results with the after the water treatment results, the degree of efficiency and performance can be determined and the future deployment of the 125 gpm full treatment system (‘hydropod’) illustrated in FIGS. 1 and 2 can be established. The mobile test and treatment device only requires 5.0 gallons to accurately simulate a performance test of the likely result of output of a high rate of flow performance equipment operating at 125 gpm. The analytical phase may determine the actual value of the following parameters as noted above using the standard procedures of volumetric, gravimetric and colorimetric low level instrumentation that can be readily performed by a technician.

Those parameters tested may include Chloride (mg/l), Iron (mg/l), Boron (mg/l), Chromium (mg/l), Sulfate (mg/l), Barium (mg/l), Copper (mg/l), Hardness (Calcium) (mg/l), COD (mg/l), solids content (dry weight per unit volume) (grams/liter), oil content from first separator (% contained), pH (established in the process).

This entire procedure can be accomplished in 2.5 hours and the data retrieved can be used as the basis for the complete operation of a high flow ‘hydro pod’ similar to the device of FIGS. 1 and 2 to treat frac and flow-back water at a rate of 125 gpm with anticipated results that will be within +/−5.0% of the accuracy established by the treatment and analytical performance module of FIG. 3. High performing instrumentation (i.e., GC, AA, x-ray etc.) will have success levels similar to those identified in this laboratory mobile treatment unit.

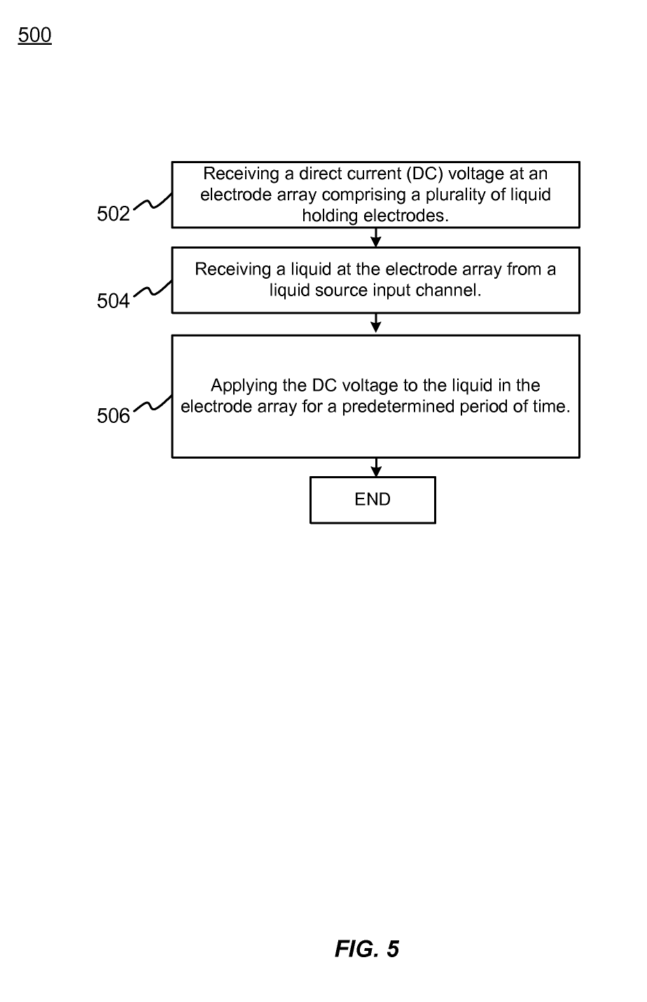

FIG. 5 illustrates an example flow diagram 500 of the operations included in an example method of operation. According to one example method of operation, the method may include receiving a direct current (DC) voltage at an electrode array comprising a plurality of liquid holding electrodes, at operation 502, receiving a liquid at the electrode array from a liquid source input channel, at operation 504, and applying the DC voltage to the liquid in the electrode array for a predetermined period of time, at operation 506.

It will be readily understood that the components of the invention, as generally described and illustrated in the figures herein, may be arranged and designed in a wide variety of different configurations. Thus, the detailed description of the embodiments is not intended to limit the scope of the invention as claimed, but is merely representative of selected embodiments of the invention.

One having ordinary skill in the art will readily understand that the invention as discussed above may be practiced with steps in a different order, and/or with hardware elements in configurations that are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

While preferred embodiments of the present application have been described, it is to be understood that the embodiments described are illustrative only and the scope of the application is to be defined solely by the appended claims when considered with a full range of equivalents and modifications (e.g., hardware devices, chemicals, ordered operations, etc.) thereto.

What is claimed is:

1. An apparatus comprising:
a liquid source input channel;
a power supply configured to provide a direct current (DC) voltage; and
an electrode array comprising a plurality of liquid holding electrodes configured to receive a liquid from the liquid source input channel and apply a direct current voltage to the liquid for a predetermined period of time.

2. The apparatus of claim 1, further comprising:
a liquid tank configured to hold the liquid; and
a gas source input channel configured to receive a gas to combine with the liquid.

3. The apparatus of claim 2, wherein the gas is a modified oxygen gas comprising three oxygen atom molecules.

4. The apparatus of claim 3, wherein the plurality of electrode cells each comprise at least one cathode and at least one anode.

5. The apparatus of claim 1, wherein the predetermined period of time is between 30 and 90 seconds.

6. The apparatus of claim 5, wherein after the predetermined period of time has elapsed the polarity of the DC voltage is reversed and a reversed DC voltage charge is applied for another predetermined period of time.

7. The apparatus of claim 6, wherein a pH reducing chemical is applied to the liquid and a polymer is applied to the liquid prior to applying the DC voltage to the liquid.

8. A method comprising:
receiving a direct current (DC) voltage at an electrode array comprising a plurality of liquid holding electrodes;
receiving a liquid at the electrode array from a liquid source input channel; and
applying the DC voltage to the liquid in the electrode array for a predetermined period of time.

9. The method of claim 8, further comprising:
reversing the polarity of the DC voltage and applying the reversed polarity DC voltage to the liquid.

10. The method of claim 8, further comprising:
providing a pH reducing chemical to the liquid prior to applying the voltage to the liquid.

11. The method of claim 8, wherein each of the plurality of electrode cells each comprises at least one cathode and at least one anode.

12. The method of claim 8, wherein the predetermined period of time is between 30 and 90 seconds.

13. The method of claim 9, further comprising:
applying a polymer to the liquid after at least one of the voltage application and the reversed polarity voltage application has occurred.

14. An apparatus comprising:
a filter configured to filter oil from a liquid;
an ozonator configured to add ozone to the liquid; and
an array of electrode cells configured to store the liquid for a predetermined amount of time and receive and apply a direct current (DC) voltage for the predetermined period of time to the liquid, and wherein after the predetermined period of time a reverse polarity DC voltage is received and applied to the liquid for a predetermined period of time.

15. The apparatus of claim 14, wherein the array of electrode cells comprise two electrode cells connected in a series wiring configuration.

16. The apparatus of claim 14, further comprising:
a tank to hold the liquid; and
a pump connected to the tank to provide the liquid to the array of electrode cells.

17. The apparatus of claim 16, wherein the tank has a capacity of five gallons.
